(19) United States
(12) Patent Application Publication
(10) Pub. No.: US 2014/0260840 A1
(43) Pub. Date: Sep. 18, 2014

(54) MACHINING APPARATUS

(71) Applicant: Kenichi Mori, Kawasaki-shi (JP)

(72) Inventor: Kenichi Mori, Kawasaki-shi (JP)

(21) Appl. No.: 14/175,176

(22) Filed: Feb. 7, 2014

(30) Foreign Application Priority Data
Mar. 12, 2013 (JP) 48622/2013

(51) Int. Cl. B23B 5/16

(52) U.S. Cl. CPC B23B 5/161
USPC 82/113

(57) ABSTRACT

In a machining apparatus, complete control of the movement, stopping, speed and displacement of a tool mounted on a rotating face plate is achieved by using a first motor to cause rotation of the face plate, causing the first motor to rotate a ring gear along with the face plate, controlling the relative speeds of the face plate and the ring gear by means of a second motor and a differential mechanism, and moving the tool on the face plate in response to a difference in the rotational speeds of the face plate and the ring gear.

### CROSS-REFERENCE TO RELATED APPLICATION

This application claims priority on the basis of Japanese patent application 48622/2013, filed Mar. 12, 2013. The disclosure of Japanese patent application 48622/2013 is incorporated by reference.

### FIELD OF THE INVENTION

The invention relates to an apparatus for machining workpieces, specifically, pipes.

### BACKGROUND OF THE INVENTION

Examples of a machining apparatus for pipes are shown and described in Japanese Patent Application Publication No. 117720/2003, published on Apr. 23, 2003, and in U.S. Pat. No. 7,320,268, granted on Jan. 22, 2008.

Each of these machining apparatuses comprises an annular housing, a face plate, a tool holder, a gear box, and a driving motor. The machining apparatus is fixed on the outside of a pipe by holding the pipe by a plurality of clamps disposed on the housing symmetrically about pipe to be machined. The face plate is rotatably supported with respect to the housing, and the tool holder, to which a machining tool is mounted, is disposed on the side of the face plate opposite from the housing. The tool is a single-point cutter used for pipe beveling, cutting, or the like.

The face plate of these machining apparatuses has a face plate gear with external teeth. A ring gear is rotatable relative to the face plate gear, but usually follows the face plate gear at the same speed and in the same direction as a result of friction. The ring gear has both outer peripheral teeth and inner peripheral teeth. The inner peripheral teeth are engaged with a power transmission input gear on a power transmission shaft. The power transmission shaft is rotatably supported inside the face plate, and has a power transmission output gear exposed on the surface of the face plate. The power transmission output gear engages a tool feeding gear in the tool holder, and the tool is moved toward or away from the pipe by rotation of the tool feeding gear through a mechanism such as a feeding screw or the like.

The driving motor transmits torque to the gears as follows. A first gear mechanism for transmitting torque from the motor to the face plate gear, and a second gear mechanism for transmitting torque to the outer peripheral teeth of the ring gear are provided in the gear box. The gear ratio of the combination of the first gear mechanism and the face plate gear is different from the gear ratio of the combination of the second gear mechanism and the ring gear. Torque is constantly transmitted to the face plate gear from the motor through the first gear mechanism. However switching, carried by a lever on the gear box, is needed to transmit torque to the ring gear through the second gear mechanism.

When only the first gear mechanism is driven, even though the torque from the motor is transmitted only to the face plate gear, the ring gear also rotates at the same speed and in the same direction as the face plate due to frictional contact with the face plate gear. Therefore, the power transmission shaft does not rotate. The face plate and the tool holder mounted thereon rotate circumferentially around the pipe with the rotation of the face plate gear. In contrast, when the lever is operated, the second gear mechanism is driven, and torque is transmitted from the motor to the ring gear through the second gear mechanism. The face plate gear and the ring gear then rotate at different speeds because the gear ratio is different between the gear ratios of the combination of the first gear mechanism and the face plate gear, and the combination of the second gear mechanism and the ring gear are different. Therefore, since the inner peripheral teeth of the ring gear rotate relative to the face plate the power transmission shaft is rotated by the power transmission input gear, and the tool moves toward or away from the pipe.

In the operation of the conventional machining apparatuses described in Japanese Patent Application Publication No. 117720/2003 and U.S. Pat. No. 7,320,268, a lever is operated in order to drive the second gear mechanism and transmit torque to the ring gear in order to move the tool toward or away from the pipe. Therefore an operator needs to control the lever directly in order to move and stop the inward and outward movement of the tool.

The rotational speed of the power transmission shaft affects the speed of movement of the tool, and the movement of the tool depends on the difference in the rotational speeds of the face plate gear and the ring gear. The difference in the rotational speeds of the face plate gear and the ring gear depends on the difference between the number of teeth on the face plate gear and the ring gear. Variations in the relative speeds of the face plate gear and the ring gear can be achieved by providing two or more sets of teeth, with different diameters, on the outer periphery of the ring gear, or by providing two or more different gear ratios in the second gear mechanism in the gear box, however, available space and cost impose limits on the variation in the relative speeds of the face plate gear and the ring gear, and the ratio of rotational speeds can have only a very limited number of discrete values, which are predetermined.

Accurate control of the feed of the tool toward the pipe under visual observation is especially important in operations such as pipe edge preparation. However, achieving such accurate control is difficult with conventional tool feed mechanisms.

Remote control of the lever, using an air cylinder or the like is possible, but limitations on the responsiveness of such remote control mechanisms make accurate control of the moving speed, moving distance, and stopping of the tool still more difficult.

### SUMMARY OF THE INVENTION

Because of the above-described problems associated with prior machining apparatuses, an objective of this invention is to provide a machining apparatus capable of improved control of the moving speed, moving distance and stopping of the tool without the need for operation of a switching lever.

Briefly, in the machining apparatus in accordance with the invention, a first motor rotates a face plate and also rotates a ring gear along with the face plate. A tool on the face plate is moved in response to a difference in the rotational speeds of the face plate and the ring gear, and the relative speeds of the face plate and the ring gear are controlled by means of a second motor through a differential mechanism.

More specifically, the machining apparatus of the invention comprises a housing, a face plate, a ring gear, and a tool holder attached to the face plate.

The face plate has a face plate gear. The face plate and ring gear are supported by the housing and rotatable with respect to the housing.

A power transmission shaft is rotatably supported by the face plate and has a power transmission input gear arranged to receiving torque from the ring gear and a power transmission output gear arranged to transmit torque from the power transmission input gear.

The tool holder attached to said face plate holds a tool, and the tool is arranged to advance and retract by linear motion converted from the torque transmitted by the power transmission output gear.

The machining apparatus also includes a differential device attached to housing. When the machining apparatus is in use, the differential device is connected to first and second driving apparatus, and transmits torque to the face plate gear and the ring gear. The differential device comprises a first gear having an axis of rotation and receiving torque from the first driving apparatus, a second gear having an axis of rotation aligned with the axis of rotation of the first gear, a planetary carrier arranged to receive torque from the second driving apparatus, and a planetary gear provided on the carrier and in engagement with the first gear and the second gear, and revolving around the common axis of the first gear and the second gear.

Torque from the first gear rotates the face plate gear and torque from the second gear rotates the ring gear.

In a preferred embodiment, the gear ratio of the first gear and the face plate gear, and the gear ratio of said second gear and the ring gear, are such that the face plate gear and the ring gear rotate at the same speed when the planetary carrier is stationary and the first gear is rotating.

In one embodiment, the axis of rotation of the planetary gear is orthogonal to the axes of rotation of said first gear and said second gear. In this embodiment, the differential device is more compact in the radial direction of the first and second gears.

In another embodiment, the axis of rotation of the planetary gear is parallel to the axes of rotation of said first gear and said second gear. In this embodiment, the differential device is more compact in the axial direction of the first and second gears.

Moving and stopping of the tool, its moving speed, and its moving distance, can be completely controlled by operating the first driving apparatus and the second driving apparatus connected with the differential device so as to control the rotational speed and rotational direction of the differential device. Thus, the lever required for controlling the operation of the conventional pipe machining apparatus is not needed.

### BRIEF DESCRIPTION OF THE DRAWINGS

FIG. 1(a) is a front elevational view of a first embodiment of the invention;

FIG. 1(b) is a side view of the first embodiment;

FIG. 2(a) is a front elevational view of a second embodiment of the invention;

FIG. 2(b) is a side view of the second embodiment;

FIG. 3 is a cross-sectional view taken on section plane 3-3 in FIG. 1;

FIG. 4 is a longitudinal sectional view of a differential device in the invention;

FIG. 5 is a schematic view of a major part of a first embodiment of a differential device in the invention;

FIG. 6 is a schematic view of a major part of a first embodiment of a differential device in the invention; and

FIG. 7 is a schematic view of a major part of a third embodiment of a differential device in the invention.

### DETAILED DESCRIPTION OF THE PREFERRED EMBODIMENTS

As shown in FIGS. 1(a) and 1(b), the machining apparatus 100 according to the first embodiment of the invention comprises a housing 10, a face plate 20 rotatable relative to the housing, a tool holder 30 fixed on the face plate 20, a differential device 60 attached to the housing, a motor M1, which serves as a first driving apparatus, and a motor M2, which serves as a second driving apparatus.

The torque capacity of motor M2 can be smaller than the torque capacity of motor M1 because a large torque is not required to rotate the planetary carrier in the differential device.

The housing 10 is annular in shape, and is fixed on the outside of a pipe P by clamps C, which are attached to the housing 10 and grip the pipe. While the housing is fixed on the outside of the pipe, face plate 20 is rotated by torque from the motor M1, and a single-point tool 38, attached to the tool holder 30, which is pressed radially inward against the pipe P, forms grooves in, and cuts, the pipe P. In some cases, the motor M2 contributes to the torque that rotates the face plate.

The apparatus 100a shown in FIGS. 2(a) and 2(b), is similar to the machining apparatus 100, but its tool holder 30a has a tool 38a for beveling the pipe P. The machining apparatus 100a operates in a manner similar to that of machining apparatus 100. Thus, the machining apparatus of the present invention can be adapted to various machining operations such as cutting or beveling pipes simply by changing the tool holder. With a suitable tool holder, for holding a welding electrode, for example, the machining apparatus can also be used as a welding machine.

The operation of the machining apparatus can be understood by reference to FIG. 3. The face plate 20 is supported by a plurality of rollers, including roller 12 and other rollers not shown, which are supported rotatably in the housing at circumferentially spaced positions. A ring gear 40 in the housing 10 is rotatably mounted on the face plate 20 by an annular part that fits slidably in an annular groove in the face plate. Alternatively, the face plate 20 and the ring gear 40 may be independently mounted for rotation in the housing 10, and in that case, friction and resulting abrasion of parts of the ring gear and face plate caused by their relative rotation can be avoided.

The face plate 20 has face plate gear teeth 22 on its outer periphery, and the ring gear 40 has both outer peripheral gear teeth 42 and inner gear teeth 44. The face plate 20 rotatably supports a power transmission shaft 50, and a power transmission input gear 52 on shaft 50 engages with the inner gear teeth 44 of the ring gear 40. (Although in the arrangement shown in FIG. 3, the power transmission shaft 50 is provided in the inside of the face plate 20, in an alternative arrangement, the power transmission shaft can be provided outside the outer periphery of the face plate 20.)

As will be described below, torque from the motors M1 and M2 is transmitted respectively to the face plate gear teeth 22 and the outer peripheral gear teeth of the ring gear 40 through separate gears. When the face plate 20 and the ring gear 40 rotate at the same speed and in the same direction, the power transmission shaft 50, being rotatably supported by the face plate 20, rotates around the common axis of rotation of the face plate 20 and the ring gear 40. Under this condition, the power transmission shaft 50 does not rotate on its own axis relative to the face plate. On the other hand, the power transmission shaft 50 rotates on its own axis relative to the face plate in one direction when the rotational speed of the ring gear 40 is higher than the rotational speed of the face plate 20, and the power transmission shaft 50 rotates around its own axis relative to the face plate in the opposite direction when the rotational speed of the ring gear 40 is lower than the rotational speed of the face plate 20. Thus, the power transmission shaft 50 rotates in one direction or the other, depending on the relationship between the speeds of the face plate 20 and the ring gear 40.

When the power transmission shaft 50 rotates on its own axis, torque is transmitted to a tool feeding bevel gear 32 through a power transmission output bevel gear 54, the torque is converted to linear motion by a linear motion converting mechanism 34, which can be, for example, a screw feeding mechanism. Alternatively, a different linear motion converting mechanism such as a rack and pinion can be used. The tool holder 36 and the tool 38 move in the direction of arrow A in FIG. 3. The direction in which the tool 38 moves depends on the rotational direction of the tool feeding gear 32, the moving speed of the tool 38 depends on the rotational speed of the tool feeding gear 32, and the distance through which the tool 38 moves depends on the amount of rotation of the tool feeding gear 32. The tool 38 does not move when the power transmission shaft 50 is not rotating around its own axis relative to the face plate.

As described above, control of moving, stopping, movement speed, and moving distance of the tool 38 is achieved by controlling rotation of the power transmission shaft 50, which depends on the rotation of the face plate 20 and the ring gear 40. FIG. 4 illustrates a differential device 60 for controlling rotation of the face plate 20 and the ring gear 40.

As shown in FIG. 4, the differential device 60 according to a first embodiment of the invention has first gears 62 and 62a, and a second gear 64, on the axis of a shaft 71. The first gears 62 and 62a are fixed to, and rotate with shaft 71, while the second gear 64 is rotatable on shaft 71. Planetary gears 68 are, provided between, and mesh with the first gear 62 and the second gear 64. The planetary gears 68 are rotatably supported by a planetary carrier 66. Providing a plurality of the planetary gears 68 is preferable so that the operation and torque transmission of the planetary gearing is stabilized. The planetary carrier 66 receives torque transmitted from motor M2 through a second intermediate input gear 74 and a second input gear 76. The planetary carrier 66 rotates around the common axis of gears 62 and 64. Consequently, the planetary gears 68 revolve around the axis of the first gear 62 and the second gear 64 while engaging with the first gear 62 and the second gear 64 as the planetary carrier 66 rotates.

A first output gear 86 receives torque transmitted from the motor M1 through a first input gear 72 and gear 62a. A second output gear 84 receives torque transmitted from the second gear 64 through gear 64a, which is integral with gear 64, and a second intermediate output gear 82. The first output gear 86 and the second output gear 84 respectively engage with the face plate gear 22 and the outer peripheral gear teeth 42 of the ring gear 40, shown in FIG. 3. Thus, torque is transmitted to the face plate gear 22 and to the outer peripheral gear 42. Because a comparatively large torque is required to rotate the face plate gear 22, it is preferable that the face plate gear 22 engage with the second output gear 86, which transmits torque directly from motor M1. Although the first gears may be composed of separate gears such as the gears 62 and 62a as illustrated in FIG. 4 when they are fixed to rotate in the same direction and at the same speed, gears 62 and 62a can be adjacent to and integral with each other as in the case of gears 64 and 64a. A torque limiter for interrupting torque when the load on the gearing exceeds a preset load may be provided where appropriate.

The basic operation of the differential device 60 will be described with reference to the schematic diagram in FIG. 5. Torque from motor M1 is transmitted to the first gear 62a through the first input gear 72 when the motor M1 is driven while the planetary carrier is fixed so that it does not rotate. Because the first gear 62a and the first gear 62 are fixed to each other so that they rotate in the same direction, torque from motor M1 is transmitted to the first gear 62a, and through first gear 62 to the planetary gears 68. At this time, if the planetary carrier 66 is prevented from rotating because motor M2 is locked, either mechanically or by servo control, the planetary gears 68 rotate in place without revolving. The planetary gears 68 then transmit torque to the second gear 64. Incidentally, because torque is transmitted from the first gear 62 to the second gear 64 through the planetary gears 68, the first gear 62 and the second gear 64 rotate in opposite directions. Torque transmitted to the second gear 64 is transmitted to the second output gear 84 through the second gear 64a and the second intermediate output gear 82.

Meanwhile, torque is transmitted to the first output gear 86 from the first gear 62a. Therefore, torque in the same direction is respectively transmitted from the first output gear 86 and the second output gear 84 to the face plate gear 22 and the outer peripheral gear teeth 42 of ring gear 40 (FIG. 3). When the gear ratio of the gear train composed of first input gear 72, the first gear 62a, the first output gear 86, and the face plate gear 22 is equal to the gear ratio of the gear train composed of first gears 62, 62a, the planetary gear 68, the second gears 64, 64a, the second intermediately output gear 82, the second output gear 84, and the outer peripheral teeth 42 of the ring gear 40, the face plate gear 22 and the ring gear 40 are rotated at the same speed and in the same direction when the driving motor M1 is rotating while the planetary carrier 66 is not rotating. Thus, controlling the rotation of the face plate gear 22 and the ring gear 40 at the same speed and in the same direction can be achieved easily. The rotation speed of the face plate gear 22 and the outer peripheral teeth 42 of ring gear 40 can be changed by changing the rotational speed of the motor M1.

When the planetary carrier 66 is made to rotate in the direction opposite to the rotational direction of the first gear 62 by operation of motor M2, the rotation speed of the planetary gears 68 is increased. Accordingly, the rotational speed of the second gear 64 is also increased, and the rotational speed of the outer peripheral gear 42 of ring gear 40 will exceed the rotational speed of the face plate gear 22. On the other hand, when the planetary carrier 66 is made to rotate in the same direction as the direction of the first gear 62, the planetary gears 68 revolve in the same direction as the direction of rotation of the first gear 62, the rotational speed of the planetary gears 68 is decreased, and the rotational speed of the second gear 64 is also decreased. Consequently the rotational speed of the outer teeth 42 of the ring gear will be lower than the rotational speed of the face plate gear 22.

Ordinarily, the motor M1 will be operated at a constant speed, and the motor M2 and the rotation of the planetary carrier 66 will be stopped. Motor M2 will be operated in one direction or the other, depending on whether or not the tool (FIG. 3) is to be advanced or withdrawn. However, constant speed of motor M1 is not required. Moreover, the rotational speed of the planetary carrier 66 can be further increased to cause the second gear 64 to stop rotating or to rotate in the reverse direction.

In summary, the rotational direction and rotational speed of the face plate gear 22 and the outer peripheral gear 42 can be controlled by operating the motor M1 when the planetary carrier 66 is fixed. Alternatively, the rotational direction and rotational speed of the face plate gear 22 can be controlled by operation of the motor M1, while the rotational direction and rotational speed of the outer peripheral gear teeth 42 of the ring gear can be controlled by operating the motor M2 to cause the planetary carrier 66 to rotate on the axes of the first gear 62 and the second gear 64. Therefore, the face plate 20 and the ring gear 40 (FIG. 3) can be reliably rotated at the same speed and in the same direction by operating motor M1 while motor M2 is not operated, and the rotation of the face plate 20 and the ring gear 40 can be controlled by operating both of motors M1 and M2. Thus, complete control of the movement, stopping, and the speed of movement, of the tool 38 (FIG. 3) can be achieved without the need for a control lever or similar device. Furthermore, the moving distance of the tool can also be controlled completely and with precision by calculating the relationship between the rotation speeds of the motors M1 and M2, and the moving speed of the tool 38. Servomotors having high controllability are preferable as driving devices. The use of motors to control tool positioning and movement also facilitates remote control of the tool.

It is also possible to rotate the face plate gear 22 and the outer peripheral teeth 42 at the same speed in the same direction by another method. Intermediate gear 82 can be eliminated, and motors M1 and M2 can be driven so as to rotate the first gear 62 and the planetary carrier 66 in the same direction while the planetary gears 68 do not rotate on their axes. At this time, since the first gear 62 and second gear 64 rotate at the same speed and in the same direction, the face plate gear 22 and the outer peripheral teeth 42 of the ring gear 40 can be rotated in the same direction. From this condition, the rotational speed of the second gear 64 can be increased with respect to the rotation speed of the first gear 62 by increasing the rotational speed of the planetary carrier 66. Alternatively, the rotational speed of the second gear 64 can be decreased with respect to the rotational speed of the first gear 62 by decreasing the rotational speed of the planetary carrier 66. The second gear 64 can also be stopped or reversely rotated by further decreasing the rotation speed of the planetary carrier 66. In this case, however, since the motors M1 and M2 both need to be driven to rotate the face plate gear 22 and the ring gear, operating the face plate gear and the ring gear at the same speed and controlling their relative speeds is more difficult.

Another embodiment of the differential device is shown in FIG. 6. The differential device 60a has a first gear 62b and a second gear 64b on a common axis, and planetary gears 68a rotatable on axes that are parallel to the common axis of gears 62b and 64b. Planetary gears 68a are provided on a planetary carrier 66a that includes a gear on its outer periphery in mesh with a second input gear 76a driven by motor M2. As the planetary carrier 66a is rotated by motor M2, the planetary gears 68a revolve around the common axis of gears 62b and 64b while in engagement with gears 62b and 64b. The first gear 62b and a first gear 62c are connected to each other and rotate in the same direction. The second gear 64b and a second gear 64c are also connected and rotate in the same direction. The operation of the differential device 60a in FIG. 6 differs from the operation of the differential device 60 in FIG. 5 with respect to rotational direction of the first gear and the second gear, however, the operation is nearly the same as that of the differential device 60. It affords complete control of the movement, stopping, and the speed of movement, of the tool, and the moving distance of the tool 38 (FIG. 3) can be controlled completely and with precision.

In still another embodiment of the differential device, shown in FIG. 7, first gears 62d and 62e can be connected directly and located adjacent each other, and second gears 64d and 64e can also be connected directly and located adjacent each other. These connections are independent. The operation, however, is similar to that of the differential device 60a in FIG. 6.

In the differential devices of this invention, various gears other than spur gears, such as helical gears and the like, can be used in the case in which the planetary gears and the first and second gears rotate on parallel axes. In the case in which the planetary gears rotate on axes orthogonal to the axes of the first and second gears, straight bevel gears and other kinds of bevel gears can be used. In short, in the invention, in which a first gear receives torque from a first driving apparatus, a second gear is provided on the same axis as the first gear, and a planetary carrier includes one or more planetary gears which engage with the first gear as well as the second gear and rotate around the axis of the first gear and the second gear, and the planetary carrier is rotated by the torque from a second driving apparatus, any of various differential devices can be utilized.

In summary, the differential device is capable of rotating a face plate and a ring gear at the same speed in the same direction exactly, when only a first driving apparatus is operated, and is capable of completely controlling the rotational speed of the face plate and the ring gear by operating both a first driving apparatus and a second driving apparatus. By virtue of its use of a differential mechanism, the machining apparatus in accordance with the invention is capable of completely and precisely controlling the moving, stopping, moving speed, and moving distance of a tool without the operation of a lever.

While several embodiments have been described, advantages of the invention can be realized through other embodiments arrived at through modifications which will be apparent from the foregoing description to persons skilled in the art. Accordingly, the invention should not be regarded as limited to the above-described embodiments, and its scope is defined solely by the following claims.

What is claimed is:

1. A machining apparatus comprising:
a housing;
a face plate having a face plate gear and a ring gear, said face plate and ring gear being supported by the housing and rotatable with respect to the housing;
a power transmission shaft rotatably supported by said face plate, said power transmission shaft having a power transmission input gear arranged to receiving torque from said ring gear and a power transmission output gear arranged to transmit torque from the power transmission input gear;
a tool holder attached to said face plate, having a tool arranged to advance and retract by linear motion converted from the torque transmitted by said power transmission output gear; and
a differential device attached to said housing, and connectable to first and second driving apparatus for transmitting torque to said face plate gear and said ring gear;
in which said differential device comprises:
a first gear for receiving torque from a first driving apparatus, said first gear having an axis of rotation and;
a second gear having an axis of rotation aligned with the axis of rotation of said first gear;
a planetary carrier arranged to receive torque from a second driving apparatus; and
a planetary gear provided on said planetary carrier, said planetary gear being in engagement with said first gear and said second gear, and revolving around the axis of said first gear and said second gear;
in which torque from said first gear rotates said face plate gear and torque from said second gear rotates said ring gear.

2. A machining apparatus according to claim 1, in which said planetary gear has an axis of rotation orthogonal to the axes of rotation of said first gear and said second gear.

3. A machining apparatus according to claim 1, in which said planetary gear has an axis of rotation parallel to the axes of rotation of said first gear and said second gear.

4. A machining apparatus according to claim 1, in which the gear ratio of said first gear and said face plate gear and the gear ratio of said second gear and said ring gear are such that said face plate gear and said ring gear rotate at the same speed when said planetary carrier is stationary and said first gear is rotating.

5. A machining apparatus according to claim 4, in which said planetary gear has an axis of rotation orthogonal to the axes of rotation of said first gear and said second gear.

6. A machining apparatus according to claim 4, in which said planetary gear has an axis of rotation parallel to the axes of rotation of said first gear and said second gear.

7. A machining apparatus according to claim 1 comprising a first driving apparatus, connected to said first gear, for applying torque to said first gear, and a second driving apparatus, connected to said planetary carrier, for applying torque to said planetary carrier.
